(19) United States
(12) Patent Application Publication
(10) Pub. No.: US 2022/0389669 A1
(43) Pub. Date: Dec. 8, 2022

(54) Paving Process

(71) Applicant: COLLABORATIVE AGGREGATES, LLC, Mill Valley, CA (US)

(72) Inventor: Wade Miller, Mill Valley, CA (US)

(73) Assignee: COLLABORATIVE AGGREGATES, LLC, Mill Valley, CA (US)

(21) Appl. No.: 17/375,115

(22) Filed: Jul. 14, 2021

Related U.S. Application Data
(63) Continuation of application No. 17/340,249, filed on Jun. 7, 2021.

(51) Int. Cl. E01C 23/03; C04B 40/00; E01C 19/23

(52) U.S. Cl. CPC E01C 23/03; C04B 40/0039; E01C 19/238; C04B 2103/14

(57) ABSTRACT

Described herein is a process for paving a surface with an asphalt paving material, comprising the steps of laying asphalt paving material on a surface to be paved; and combining an asphalt rejuvenator and the asphalt paving material; wherein the asphalt rejuvenator and the asphalt paving material are combined immediately before, concurrently with, or immediately after the asphalt paving material is laid on the surface to be paved. The asphalt paving material may be virgin asphalt, or it may comprise reclaimed asphalt pavement and/or recycled asphalt shingles.

### CROSS-REFERENCE TO RELATED APPLICATIONS

This application is a continuation of U.S. application Ser. No. 17/340,249, filed Jun. 7, 2021, the contents of which are incorporated herein by reference in their entirety.

### BACKGROUND

It has long been known in the art that asphalt paving material can stick to paving equipment. In an effort to address this problem, it is typical in the art to spray the equipment and/or the freshly laid pavement with water. Towards this end, modern paving equipment is often provided with a built-in spraying apparatus and/or other means for applying water to the equipment and/or freshly laid pavement, and water tanks to provide a source of water.

It is also known in the art that aging pavement may be “refreshed” by applying a pavement “rejuvenator” to the surface of the pavement. Such a rejuvenator, when applied to old pavement, can extend the life of the pavement by months and/or years by reducing cracking of the pavement surface.

### SUMMARY

The present inventors have surprisingly discovered that applying a pavement rejuvenator directly to freshly laid pavement, instead of plain water, provides for a longer-lasting and otherwise superior pavement surface. By using the existing spraying equipment already built into modern paving equipment, the rejuvenator provides the added benefit of reducing/preventing asphalt from sticking to the equipment.

Accordingly, in one aspect, the present invention provides a process for paving a surface with an asphalt paving material, comprising the steps of: (a) laying asphalt paving material on a surface to be paved; and (b) combining an asphalt rejuvenator and the asphalt paving material; wherein the asphalt rejuvenator and the asphalt paving material are combined immediately before, concurrently with, or immediately after the asphalt paving material is laid on the surface to be paved.

In another aspect, the asphalt rejuvenator used in this process comprises: (a) a carrier matrix; and (b) an agent selected from the group consisting of a curing agent and a masked curing agent. In some embodiments, the asphalt rejuvenator further comprises (d) a surfactant.

### DETAILED DESCRIPTION

Unless specifically noted otherwise herein, the definitions of the terms used are standard definitions used in the arts of organic synthesis and civil engineering. Exemplary embodiments, aspects and variations are illustrated in the figures and drawings, and it is intended that the embodiments, aspects and variations, and the figures and drawings disclosed herein are to be considered illustrative and not limiting.

As used herein, “carrier matrix” refers to a substrate that is used to incorporate the asphalt rejuvenator of this invention to the asphalt mixture. The carrier matrix may be an oil, or an oil-in-water emulsion.

As used herein, a “curing agent” is a substance that contributes to the rejuvenation or “warm mix” properties of the invention.

As used herein, “masked curing agent” is a substance that is capable of transforming into a curing agent during the process of rejuvenation or warm mix formation or application of an asphalt mixture.

### Asphalt Rejuvenators

The present invention provides asphalt rejuvenators that are useful in, among other things, helping to rejuvenate recycled, reclaimed or recovered asphalt paving material and/or asphalt binders, permitting asphalt paving material preparation at more suitable temperatures (i.e., “warm mix” instead of “hot mix”), improving the performance grade of the asphalt paving material, or aiding compaction of asphalt material by reducing the number of air voids in the mixture.

These rejuvenators comprise a carrier matrix, and a curing agent or a masked curing agent or both. In some embodiments the rejuvenator may also include a surfactant.

A. Carrier matrices. A carrier matrix useful in the method described herein may be a substrate that incorporates the asphalt rejuvenator of this invention to the asphalt paving material. The carrier matrix may be an oil or an oil-in-water emulsion. Suitable carrier matrices may solvate the curing agent and/or the masked curing agent and facilitate the mixing and interaction of the curing agent and/or masked curing agent with the asphalt paving material.

Exemplary carrier matrix oils include, but are not limited to, organic oils such as paraffinic oils or waxes, aromatic oils such as hydrolene, canola oil, coconut oil, linseed oil, safflower oil, soybean oil, tall oil, or tung oil, or inorganic oils such as mineral oils or silicone oils, or mixtures thereof.

Exemplary carrier matrix emulsions for use in the method described herein are water emulsions of the above oils. These water emulsions may be 1 to 80% oil, alternatively 5 to 50% oil, alternatively 10 to 25% oil.

B. Curing agents. Curing agents useful in the method described herein may be substances that contribute to the rejuvenation or “warm mix” properties of the rejuvenator. Exemplary curing agents may have the general structure:

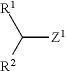

wherein each R¹ and R² is independently selected from the group consisting of hydrogen or (C₁-C₁₈) linear or branched alkyl or alkenyl, wherein each (C₁-C₁₈) linear or branched alkyl or alkenyl is unsubstituted or substituted with one or more substituents selected from the group consisting of halo, nitro, trifluoromethyl, trifluoromethoxy, methoxy, carboxy, —NH₂, —OH, —SH, —NHCH₃, —N(CH₃)₂, —SCH₃, —CN, aryl and heteroaryl, further wherein at least one of R¹ and R² is not hydrogen, and at least one of R¹ and R² is (C₁-C₁₂) linear or branched alkyl or alkenyl substituted with —OH, —SH, —COOH or —NH₂, or R¹—C—R² together form a ring structure selected from (C₃-C₁₀)cycloalkyl, aryl and heteroaryl, unsubstituted or substituted with one or more substituents selected from the group consisting of halo, nitro, trifluoromethyl, trifluoromethoxy, methoxy, carboxy, —NH₂, —OH, —SH, —NHCH₃, —N(CH₃)₂, —SCH₃, —CN, (C₁-C₆)alkyl, and substituted (C₁-C₆)alkyl, and Z¹ is selected from the group consisting of —COOH, —SO₃H, —SO₂H, —OSO₃H, —PO₃H₂, —OPO₃H₂, and —OSi(R′)(R″)OH, wherein R′ and R″ are independently H or (C₁-C₁₂) linear or branched alkyl or alkoxy.

The asphalt rejuvenators described herein, when containing a curing agent, may be 1 to 50% (w/w) curing agent, more preferably 1 to 25% curing agent, most preferably 1 to 5% curing agent. Exemplary curing agents include, but are not limited to, ascorbic acid, benzoic acid, pthalic acid, cinnamic acid, citric acid, 2-pyridine carboxylic acid, salicylic acid and stearic acid.

C. Masked Curing Agents. The masked curing agents useful in the process described herein are substances that are capable of transforming into curing agents during the process of rejuvenation or warm mix formation or application. Preferred masked curing agents of this invention have the general structure

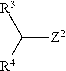

wherein each R³ and R⁴ is independently selected from the group consisting of hydrogen or (C₁-C₁₈) linear or branched alkyl or alkenyl, wherein each (C₁-C₁₈) linear or branched alkyl is unsubstituted or substituted with 1 or more substituents selected from the group consisting of halo, nitro, trifluoromethyl, trifluoromethoxy, methoxy, carboxy, —NH₂, —OH, —SH, —NHCH₃, —N(CH₃)₂, —SCH₃, —CN, aryl and heteroaryl, further wherein at least one of R³ and R⁴ is not hydrogen, and at least one of R³ and R⁴ is (C₁-C₁₂) linear or branched alkyl or alkenyl substituted with —OH, —SH, —COOH or —NH₂, or R³—C—R⁴ together form a ring structure selected from (C₃-C₁₀)cycloalkyl, aryl and heteroaryl, unsubstituted or substituted with 1 or more substituents selected from the group consisting of halo, nitro, trifluoromethyl, trifluoromethoxy, methoxy, carboxy, —NH₂, —OH, —SH, —NHCH₃, —N(CH₃)₂, —SCH₃, —CN, (C₁-C₆)alkyl, and substituted (C₁-C₆)alkyl, and Z² is selected from the group consisting of —COOR, —SO₃R, —SO₂R —OSO₃R, —PO₃HR, —OPO₃HR, and —OSi(R′)(R″)OR where R′ and R″ are independently H or (C_{1—}C₁₂) linear or branched alkyl or alkoxy, and further wherein R is (C₁—C₁₂) linear or branched alkyl.

The asphalt rejuvenators described herein, when containing a masked curing agent, may be 0.1 to 50% (w/w) masked curing agent, or 0.1 to 25% masked curing agent, or 0.1 to 5% masked curing agent.

In alternative embodiments the masked curing agent is methyl-, ethyl-, isopropyl- or hexyl salicylate.

D. Surfactants. The surfactants useful in the present invention include, but are not limited to, hydrophilic surfactants, lipophilic surfactants, and mixtures thereof. That is, a mixture of hydrophilic surfactants may be employed, a mixture of lipophilic surfactants may be employed, or a mixture of at least one hydrophilic surfactant and at least one lipophilic surfactant may be employed.

Hydrophilic surfactants may be either ionic or non-ionic. Suitable ionic surfactants include, but are not limited to, alkylammonium salts; fusidic acid salts; fatty acid derivatives of amino acids, oligopeptides, and polypeptides; glyceride derivatives of amino acids, oligopeptides, and polypeptides; lecithins and hydrogenated lecithins; lysolecithins and hydrogenated lysolecithins; phospholipids and derivatives thereof; lysophospholipids and derivatives thereof; carnitine fatty acid ester salts; salts of alkylsulfates; fatty acid salts; sodium docusate; acylactylates; mono- and di-acetylated tartaric acid esters of mono- and di-glycerides; succinylated mono- and di-glycerides; citric acid esters of mono- and di-glycerides; and mixtures thereof.

Within the aforementioned group, ionic surfactants include, by way of example: lecithins, lysolecithin, phospholipids, lysophospholipids and derivatives thereof; carnitine fatty acid ester salts; salts of alkylsulfates; fatty acid salts; sodium docusate; acylactylates; mono- and di-acetylated tartaric acid esters of mono- and di-glycerides; succinylated mono- and di-glycerides; citric acid esters of mono- and di-glycerides; and mixtures thereof.

Ionic surfactants may be the ionized forms of lecithin, lysolecithin, phosphatidylcholine, phosphatidylethanolamine, phosphatidylglycerol, phosphatidic acid, phosphatidylserine, lysophosphatidylcholine, lysophosphatidylethanolamine, lysophosphatidylglycerol, lysophosphatidic acid, lysophosphatidylserine, PEG-phosphatidylethanolamine, PVP-phosphatidylethanolamine, lactylic esters of fatty acids, stearoyl-2-lactylate, stearoyl lactylate, succinylated monoglycerides, mono/diacetylated tartaric acid esters of mono/diglycerides, citric acid esters of mono/diglycerides, cholylsarcosine, caproate, caprylate, caprate, laurate, myristate, palmitate, oleate, ricinoleate, linoleate, linolenate, stearate, lauryl sulfate, teracecyl sulfate, docusate, lauroyl carnitines, palmitoyl carnitines, myristoyl carnitines, and salts and mixtures thereof.

Hydrophilic non-ionic surfactants may include, but not limited to, alkylglucosides; alkylmaltosides; alkylthioglucosides; lauryl macrogolglycerides; polyoxyalkylene alkyl ethers such as polyethylene glycol alkyl ethers; polyoxyalkylene alkylphenols such as polyethylene glycol alkyl phenols; polyoxyalkylene alkyl phenol fatty acid esters such as polyethylene glycol fatty acids monoesters and polyethylene glycol fatty acids diesters; polyethylene glycol glycerol fatty acid esters; polyglycerol fatty acid esters; polyoxyalkylene sorbitan fatty acid esters such as polyethylene glycol sorbitan fatty acid esters; hydrophilic transesterification products of a polyol with at least one member of the group consisting of glycerides, vegetable oils, hydrogenated vegetable oils, fatty acids, and sterols; polyoxyethylene sterols, derivatives, and analogues thereof; polyoxyethylated vitamins and derivatives thereof; polyoxyethylene-polyoxypropylene block copolymers; and mixtures thereof; polyethylene glycol sorbitan fatty acid esters and hydrophilic transesterification products of a polyol with at least one member of the group consisting of triglycerides, vegetable oils, and hydrogenated vegetable oils. The polyol may be glycerol, ethylene glycol, polyethylene glycol, sorbitol, propylene glycol, pentaerythritol, or a saccharide.

Other hydrophilic-non-ionic surfactants include, without limitation, PEG-10 laurate, PEG-12 laurate, PEG-20 laurate, PEG-32 laurate, PEG-32 dilaurate, PEG-12 oleate, PEG-15 oleate, PEG-20 oleate, PEG-20 dioleate, PEG-32 oleate, PEG-200 oleate, PEG-400 oleate, PEG-15 stearate, PEG-32 distearate, PEG-40 stearate, PEG-100 stearate, PEG-20 dilaurate, PEG-25 glyceryl trioleate, PEG-32 dioleate, PEG-20 glyceryl laurate, PEG-30 glyceryl laurate, PEG-20 glyceryl stearate, PEG-20 glyceryl oleate, PEG-30 glyceryl oleate, PEG-30 glyceryl laurate, PEG-40 glyceryl laurate, PEG-40 palm kernel oil, PEG-50 hydrogenated castor oil, PEG-40 castor oil, PEG-35 castor oil, PEG-60 castor oil, PEG-40 hydrogenated castor oil, PEG-60 hydrogenated castor oil, PEG-60 corn oil, PEG-6 caprate/caprylate glycerides, PEG-8 caprate/caprylate glycerides, polyglyceryl-10 laurate, PEG-30 cholesterol, PEG-25 phyto sterol, PEG-30 soya sterol, PEG-20 trioleate, PEG-40 sorbitan oleate, PEG-80 sorbitan laurate, polysorbate 20, polysorbate 80, POE-9 lauryl ether, POE-23 lauryl ether, POE-10 oleyl ether, POE-20 oleyl ether, POE-20 stearyl ether, tocopheryl PEG-100 succinate, PEG-24 cholesterol, polyglyceryl-10 oleate, Tween 40, Tween 60, sucrose monostearate, sucrose monolaurate, sucrose monopalmitate, PEG 10-100 nonyl phenol series, PEG 15-100 octyl phenol series, and poloxamers.

Suitable lipophilic surfactants include, by way of example only: fatty alcohols; glycerol fatty acid esters; acetylated glycerol fatty acid esters; lower alcohol fatty acids esters; propylene glycol fatty acid esters; sorbitan fatty acid esters; polyethylene glycol sorbitan fatty acid esters; sterols and sterol derivatives; polyoxyethylated sterols and sterol derivatives; polyethylene glycol alkyl ethers; sugar esters; sugar ethers; lactic acid derivatives of mono- and di-glycerides; hydrophobic transesterification products of a polyol with at least one member of the group consisting of glycerides, vegetable oils, hydrogenated vegetable oils, fatty acids and sterols; oil-soluble vitamins/vitamin derivatives; and mixtures thereof. Within this group, suitable lipophilic surfactants include, but are not limited to, glycerol fatty acid esters, propylene glycol fatty acid esters, and mixtures thereof, or are hydrophobic transesterification products of a polyol with at least one member of the group consisting of vegetable oils, hydrogenated vegetable oils, and triglycerides.

In some embodiments, the surfactant is selected from the group consisting of Span20®, Span60®, TritonX100®, Triton X305®, Mowiol 18-88®, (all Sigma-Aldrich, St. Louis, Mo.), Tween20® (Fisher Scientific, Fair Lawn, N.J.), Dowfax2A1®, Dowfax 8390® (both The Dow Chemical Co., Midland, Mich.), Surfynol 104A®, Surfynol DF62®, Dynol 604® (all Air Products and Chemicals, Inc., Allentown, Pa.), Pluronic F108 Pastilles® (BASF Corp., Florham Park, N.J.), Aerosol A103® (Cytec Industries, Inc., Woodland Park, N.J.), lecithin, dodecyl benzene sulfonic acid sodium salt and gum Arabic. In some embodiments, the surfactant is Tween20®.

The asphalt rejuvenators of the invention, when containing a surfactant, may be 0.1 to 5% (w/w) surfactant, more preferably 0.1 to 1% surfactant. In some embodiments, the asphalt rejuvenator of the invention is 0.5% surfactant. In some embodiments, the asphalt rejuvenator of the invention is 0.5% Tween20® or 1% Tween20®.

E. Other Rejuvenators. Suitable asphalt rejuvenators, in addition to those described above, may comprise one or more ingredients, including aromatic extracts, maltene, asphaltene, tall oil (liquid rosin, tallol), napthenic oil, polyamines, vegetable oils (e.g., soy oil, corn oil), flux oils, aromatic oils, paraffin oil, animal fats and greases, oleic acid, coal tar, uintaite) (Gilsonite® , re-refined engine oil bottoms residue (“REOB”), Vacuum Tower Asphalt Extender (“VTAE”), repurposed vegetable oil, hydro-processed heavy paraffinic process oil, heavy naphthenic process oil, Fischer-Tropsch wax, polymerized asphalt, high viscosity aromatic oils, coal tar,

Examples of commercially-available asphalt rejuvenators which may be used in the process described herein include, but are not limited to, Delta Mist® (Collaborative Aggregates); Hydrolene 90T (HollyFrontier); Hydrolene LPH (HollyFrontier); Kendex® MNE (American Refining); Raffex® (San Joaquin Refining); Cyclogen® L & M (Tricor Refining); Cyclogen® LE & ME (Tricor Refining); SylvaRoad™ RP-1000 (Arizona Chemical/Kraton); Evoflex® (Ingevity); Sonnegreen (Sonneborne); ReVive® 1114 (ArrMaz/Arkema); ACF Iterlene 1000 (Iterchimica); Anova® 1815/1845 (Cargill); JIVE™ (Poet); Invigorate (Colorbiotics); MaxxChem RJ1 (ArrMaz/Arkema); RAPpave (Manchester Pavement Solutions); ReGen® (Blacklidge); ReLIXER™/ReJUVN8™ (Sripath Technologies); NuMIXER™/ReSTORE (Sripath Technologies) ReNUBIT™ /ReGENR8™ (Sripath Technologies); TUFFTREK 4002 (Georgia Pacific); HyPrene BO300/P100N (Ergon Refining, Inc.), ValAro 130A° (PBF Energy); Paxole 1009 (Pax International); ParaLux® (Chevron); Cyclepave (Witco Chemical Company); Viplex 50 (Crowley Chemicals); Storbit (Sasol); Storflux (Sasol); PASS-OB®, PASS-CR® (Asphalt Systems) Reclamite® (Tricor Refining); CRF® emulsion (Tricor Refining); ERA-1, ERA-25, ERA-50 emulsions (Ergon, Inc.); RePlay™ (BioSpan Technologies); Viplex 19 (Crowley Chemicals); BIORESTOR® (Bio-based Spray Systems); Paverx (Chemtek, Inc.); PelletRAP™ & PelletPATCH (Phoenix Industries); WD 2000™ (Lone Star Specialties); PDC (e.g., Pavement Restoration Technology Systems); RejuvaSeal® (Pavement Rejuvenation International); and ReGenX® (Blacklidge).

F. Methods of Making and Using Emulsions. When the carrier matrix is an emulsion, the asphalt rejuvenator may be produced using processes such as paddle mixing or stirring, sonication, a Sonolator® (Sonic Corporation, Stratford, Conn.) or a single piston pump. Large scale production of such compositions may employ single or multiple streams of the components (and an optional surfactant) converging under increased pressure, then exiting the equipment as a single stream of product. Such emulsions are mainly produced at ambient temperatures, but elevated temperatures may also be used.

When the carrier matrix is an emulsion, the asphalt rejuvenator may be used by applying directly to the surface of existing asphalt paving material. When employed in this fashion, paving material is preserved by preventing onset of the top-down cracking that is common in aged pavement, thereby extending the life of existing asphalt pavement.

When employed in this fashion, the asphalt rejuvenator is applied at a dose rate from 0.01 to 0.2 gallons/sq.yd.

### Process for Paving

Also provided herein is a process for paving a surface with an asphalt paving material, comprising the steps of laying asphalt paving material on a surface to be paved; and combining an asphalt rejuvenator and the asphalt paving material; wherein the asphalt rejuvenator and the asphalt paving material are combined immediately before, concurrently with, or immediately after the asphalt paving material is laid on the surface to be paved. The asphalt paving material may be virgin asphalt, or it may comprise reclaimed asphalt pavement and/or recycled asphalt shingles.

In one embodiment of the process described herein, the asphalt rejuvenator is sprayed onto the asphalt immediately after the asphalt paving material is laid on the surface to be paved. The process described herein may comprise a step of compacting the asphalt paving material after it is laid on the surface to be paved. In a process which comprises a compacting step, the asphalt rejuvenator may be spread onto the asphalt before the compacting step; alternatively, the asphalt rejuvenator may be applied following the compacting step. Where the process comprises a compacting step, the asphalt rejuvenator may be applied directly to the rollers, using any suitable means for applying the asphalt to the rollers. For example, in one embodiment, the asphalt rejuvenator is applied directly to the rollers by spraying on the rollers. In an alternative paving process described herein the asphalt rejuvenator may be spread onto the asphalt by spraying the rejuvenator directly onto the asphalt.

Asphalt rejuvenators which are suitable for spraying in a process described herein will be liquids with a viscosity which enables the rejuvenator to be sprayed using the existing spraying apparatus on road paving vehicles without the need for adaptation of the apparatus. In one embodiment, the viscosity of the rejuvenator will be no more than about 1000 cP (the viscosity of castrol oil). In an alternative embodiment, the viscosity of the rejuvenator will be no more than about 900 cP (the upper end of the range of viscosity of SAE 40 motor oil). In another alternative embodiment, the viscosity of the rejuvenator will be no more than about 650 cP (the upper end of the range of viscosity of SAE 30 motor oil). In another alternative embodiment, the viscosity of the rejuvenator will be no more than about 420 cP (the upper end of the range of viscosity of SAE 20 motor oil). In another alternative embodiment, the viscosity of the rejuvenator will be no more than about 140 cP (the upper end of the range of viscosity of SAE 10 motor oil). In another alternative embodiment, the viscosity of the rejuvenator will be no more than about 10 cP. In another alternative embodiment, the viscosity of the rejuvenator will be no more than about 1 cP (the viscosity of water). In this context, the term “about” will be understood to refer to the property of liquids that their viscosity varies reliably with temperature, so that a viscosity value of “about” a particular number will encompass a range of values that includes the variation in viscosity across the range of temperatures encountered by those skilled in the art when laying asphalt pavement.

### EXAMPLE 1—FORMULATION OF EXEMPLARY REJUVENATORS

Rejuvenator composition A consists of 1 wt % salicylic acid and 99 wt % linseed oil. In a typical preparation of composition A, Raw Linseed Oil (6.5 pounds, density 7.78 lb/gal, 0.932 g/mL) was weighed into a gallon can. Salicylic acid (32 g) was added while the mixture was being stirred with a Ross HSM-C.

Rejuventator composition B, consisting of 2% salicylic acid, 0.5% methyl salicylate, and 97.5% linseed oil, is prepared as above. The methyl salicylate was added to the mix of salicylic acid and linseed oil after all the salicylic acid has dissolved.

Rejuvenator composition C, consisting of 2% salicylic acid, 0.1% methyl salicylate, and 97.9% linseed oil, is prepared as above. The methyl salicylate was added to the mix of salicylic acid and linseed oil after all the salicylic acid has dissolved.

### EXAMPLE 2—PREPARATION OF EMULSIONS

The following oil-in-water emulsions were prepared from Composition A:

Emulsion D: 10% Composition A in 89% H₂O plus 1% Tween 20®;
Emulsion E: 20% Composition A in 79% H₂O plus 1% Tween 20®;
Emulsion F: 20% Composition A in 79.5% H₂O plus 0.5% Tween 20®.

### EXAMPLE 3—APPLICATION OF REJUVENATOR DURING PAVING PROCESS USING EXISTING SPRAYING EQUIPMENT

This test project was part of a conventional asphalt paving project approximately 5 miles long. The trial of roller rejuvenation consisted of 2,182 sq. yards of newly compacted asphalt. The rejuvenator employed in the test was a plant-based, solvent-free bio-rejuvenator (Delta Mist®, Collaborative Aggregates LLC) as the asphalt rejuvenating agent.

The new hot mix pavement consisted of a PG 58-28 utilizing 25% Recycled Asphalt Pavement (RAP) and no other recycled materials. Roller rejuvenation took place over a section of pavement being compacted by use of the intermediary rollers consisting of the rubber tire pneumatic roller with Delta Mist® replacing the standard water normally sprayed. During the compaction process, 45.28 gallons of Delta Mist was sprayed, and the application rate was determined to be 0.02 gallons per square yard over 0.31 mile at 12 ft wide.

### Observations

Desired compaction was achieved. Visual inspection showed that application of the rejuvenator material made the fresh asphalt mat darker in color than asphalt without rejuvenator. Areas on which the rejuvenator was applied were easily differentiated due in part to the apparent milky white color surface sheen observed during the break and cure process. Minor striping was observed but not enough to cause concern or to halt the trial. The rejuvenator cleaned out the hard water deposits already present in the rollers that once broke free, temporarily plugged their spray nozzles but cleared quickly. Monthly follow up inspections of pavement will be conducted and are expected to show that application of the rejuvenator retards the oxidation process and slows top-down cracking of the pavement.

### Example 4—Application of Rejuvenator During Paving Process by Applying Rejuvenator to Steel Drum Breakdown Roller

This test project is part of a conventional asphalt paving project. The rejuvenator employed in the test is a plant-based, solvent-free bio-rejuvenator (Delta Mist®, Collaborative Aggregates LLC) as the asphalt rejuvenating agent.

The new hot mix pavement consists of a PG 58-28 utilizing 25% Recycled Asphalt Pavement (RAP) and no other recycled materials. Roller rejuvenation takes place over a section of pavement being compacted by use of the intermediary rollers consisting of the rubber tire pneumatic roller with Delta Mist® being applied to the steel drum breakdown roller.

1. A process for paving a surface with an asphalt paving material, comprising the steps of
laying asphalt paving material on a surface to be paved; and
compacting the asphalt material by means of rollers after it is laid on the surface to be paved;
and
applying an asphalt rejuvenator to the asphalt material in a continuous layer by applying the rejuvenator to the rollers during the paving process,
wherein the asphalt rejuvenator comprises one or more ingredients selected from the group consisting of tall oil, napthenic oil, vegetable oil, linseed oil, flux oil, aromatic oil, paraffin oil, re-refined engine oil bottoms residue, Vacuum Tower Asphalt Extender, hydro-processed heavy paraffinic process oil, and heavy naphthenic process oil.

2. The process of claim 1 wherein the asphalt paving material comprises reclaimed asphalt pavement.

3. The process of claim 1, wherein the asphalt paving material is virgin asphalt.

4. (canceled)

5. (canceled)

6. (canceled)

7. (canceled)

8. (canceled)

9. (canceled)

10. (canceled)

11. A process for paving a surface with an asphalt paving material, comprising the steps of
laying asphalt paving material on a surface to be paved; and
compacting the asphalt material by means of rollers after it is laid on the surface to be paved;
and
applying an asphalt rejuvenator to the rollers during the paving process, wherein the asphalt rejuvenator comprises
(a) a carrier matrix; and
(b) an agent selected from the group consisting of a curing agent and a masked curing agent.

12. The process of claim 11 wherein the agent is a curing agent.

13. The process of claim 11 wherein the agent is a masked curing agent.

14. The process of claim 11 wherein the agent comprises both a curing agent and a masked curing agent.

15. The process of claim 11 wherein the carrier matrix is an oil or an emulsion.

16. The process of claim 15 wherein the carrier matrix is an oil is selected from the group consisting of paraffinic oils or waxes, hydrolene, canola oil, coconut oil, linseed oil, safflower oil, soybean oil, tall oil, or tung oil, mineral oils, silicone oils, and mixtures thereof.

17. The process of claim 11 wherein the curing agent comprises a compound of formula 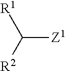
wherein
each R¹ and R² is independently selected from the group consisting of hydrogen or (C₁*C₁₈) linear or branched alkyl or alkenyl, wherein each (C₁-C₁₈) linear or branched alkyl or alkenyl is unsubstituted or substituted with one or more substituents selected from the group consisting of halo, nitro, trifluoromethyl, trifluoromethoxy, methoxy, carboxy, —NH₂, —OH, —SH, —NHCH₃, —N(CH₃)₂, —SCH₃, —CN, aryl and heteroaryl, further wherein at least one of R¹ and R² is not hydrogen, and at least one of R¹ and R² is (C₁-C₁₂) linear or branched alkyl or alkenyl substituted with —OH, —SH, —COOH or —NH₂, or
R¹—C—R² together form a ring structure selected from (C₃-C₁₀)cycloalkyl, aryl and heteroaryl, unsubstituted or substituted with one or more substituents selected from the group consisting of halo, nitro, trifluoromethyl, trifluoromethoxy, methoxy, carboxy, —NH₂, —OH, —SH, —NHCH₃, —N(CH₃)₂, —SCH₃, —CN, (C₁-C₆)alkyl, and substituted (C₁-C₆)alkyl, and
Z¹ is selected from the group consisting of —COOH, —SO₃H, —SO₂H, —OSO₃H, —PO₃H₂, —OPO₃H₂, and —OSi(R′)(R″)OH, wherein R′ and R″ are independently H or (C₁-C₁₂) linear or branched alkyl or alkoxy.

18. The process of claim 17 wherein the curing agent is selected from the group consisting of ascorbic acid, benzoic acid, phthalic acid, cinnamic acid, citric acid, 2-pyridine carboxylic acid, salicylic acid and stearic acid.

19. The process of claim 11 wherein the masked curing agent comprises 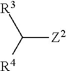
wherein
each R³ and R⁴ is independently selected from the group consisting of hydrogen or (C₁-C₁₈) linear or branched alkyl or alkenyl, wherein each (C₁-C₁₈) linear or branched alkyl is unsubstituted or substituted with 1 or more substituents selected from the group consisting of halo, nitro, trifluoromethyl, trifluoromethoxy, methoxy, carboxy, —NH₂, —OH, —SH, —NHCH₃, —N(CH₃)₂, —SCH₃, —CN, aryl and heteroaryl, further wherein at least one of R³ and R⁴ is not hydrogen, and at least one of R³ and R⁴ is (C₁-C₁₂) linear or branched alkyl or alkenyl substituted with —OH, —SH, —COOH or —NH₂, or
R³—C—R⁴ together form a ring structure selected from (C₃-C₁₀)cycloalkyl, aryl and heteroaryl, unsubstituted or substituted with 1 or more substituents selected from the group consisting of halo, nitro, trifluoromethyl, trifluoromethoxy, methoxy, carboxy, —NH₂, —OH, —SH, —NHCH₃, —N(CH₃)₂, —SCH₃, —CN, (C₁-C₆)alkyl, and substituted (C₁-C₆)alkyl, and
Z² is selected from the group consisting of —COOR, —SO₃R, —SO₂R —OSO₃R, —PO₃HR, —OPO₃HR, and —OSi(R′)(R″)OR where R′ and R″ are independently H or (C₁-C₁₂) linear or branched alkyl or alkoxy, and further wherein R is (C₁-C₁₂) linear or branched alkyl.

20. The process of claim 19 wherein the masked curing agent is selected from the group consisting of methyl-, ethyl-, isopropyl- and hexyl salicylate.
